(19) United States
(12) Patent Application Publication
(10) Pub. No.: US 2026/0136029 A1
(43) Pub. Date: May 14, 2026

(54) METHOD OR APPARATUS RESCALING A TENSOR OF FEATURE DATA USING INTERPOLATION FILTERS

(71) Applicant: InterDigital VC Holdings, Inc., Wilmington, DE (US)

(72) Inventors: Hyomin Choi, Sunnyvale, CA (US); Fabien Racape, San Francisco, CA (US); Ezgi Ozyilkan, New York, NY (US); Syed Mateen Ul haq, Mountain View, CA (US)

(21) Appl. No.: 19/118,933

(22) PCT Filed: Oct. 2, 2023
(86) PCT No.: PCT/US2023/034255

§ 371 Date: Apr. 7, 2025

Related U.S. Application Data
(60) Provisional application No. 63/414,053, filed on Oct. 7, 2022.

(51) Int. Cl. H04N 19/33; G06V 10/82; H04N 19/117; H04N 19/187; H04N 19/46; H04N 19/70; H04N 19/85

(52) U.S. Cl. CPC H04N 19/33; G06V 10/82; H04N 19/117; H04N 19/187; H04N 19/46; H04N 19/70; H04N 19/85

(57) ABSTRACT

At least a method and an apparatus are presented for efficiently encoding or decoding video using neural networks wherein the bitstream is adapted to hybrid machine/human vision applications. For example, the scalable decoding comprises applying to a tensor of reconstructed data a neural network-based feature synthesis processing to generate a tensor of input feature representative of a feature of image data samples, resizing the tensor of input feature to generate a tensor of output feature intended to be fed a neural network-based vision inference processing to generate a collection of inference results. Advantageously, resizing the tensor of input feature adapt at least a dimension of the tensor of input feature to the neural network-based vision inference processing.

### CROSS REFERENCE TO RELATED APPLICATIONS

This application claims the benefit of U.S. Provisional Application No. 63/414,053, filed Oct. 7, 2020, which is incorporated herein by reference in its entirety.

### TECHNICAL FIELD

At least one of the present embodiments generally relates to a method or an apparatus for video encoding or decoding, and more particularly, to a method or an apparatus for decoding a video using scalable NN-based transforms, the decoding further comprising rescaling a tensor of feature data intended to be fed to a NN-based vision inference task.

### BACKGROUND

Traditional compression standards reach low bitrates by transforming and degrading the video content using methods optimized to preserve signal fidelity or visual quality. To that end, traditional image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

In recent years, novel image and video compression methods based on neural networks (NNs) have been developed. In contrast with traditional methods which apply pre-defined prediction modes and transforms, neural network-based methods rely on many parameters that are learned on a large dataset during a training stage, by iteratively minimizing a loss function using some gradient descent algorithm. In the case of compression, the loss function is defined by the rate-distortion cost, where the rate stands for the estimation of the bitrate of the encoded bitstream, and the distortion quantifies the quality of the decoded video against the original input with respect to some visual quality metric. Traditionally, the quality of the decoded input image is optimized, for example based on the measure of the mean squared error or an approximation of the human-perceived visual quality.

However, an increasing amount of visual content is now also analyzed directly by machines via deep learning-based computer vision algorithms. Existing methods for coding and decoding show some limitations as compression schemes are not optimized for computer vision algorithms. Therefore, there is a need to improve the state of the art by proposing a compression scheme of images and videos targeting both human and machine consumption.

### SUMMARY

The drawbacks and disadvantages of the prior art are solved and addressed by the general aspects described herein.

According to a first aspect, there is provided a method. The method comprises scalable video decoding by obtaining a tensor of reconstructed data representative of image data samples partially reconstructed from a base layer of a bitstream, the tensor of reconstructed data comprises a number of channels of two-dimensional data; applying to the tensor of reconstructed data a neural network-based feature synthesis processing to generate a tensor of input feature representative of a feature of image data samples, the tensor of input feature comprises a number of channels of two-dimensional data; resizing the tensor of input feature to generate a tensor of output feature, the tensor of output feature comprises a number of channels of two-dimensional data; and applying to the tensor of output feature, a neural network-based vision inference processing to generate a collection of inference results. Advantageously, resizing the tensor of input feature comprises applying at least one interpolation filter to the tensor of input feature to adapt at least a dimension of the tensor of input feature to the neural network-based vision inference processing.

According to another aspect, there is provided an apparatus. The apparatus comprises one or more processors, wherein the one or more processors are configured to implement the method for video decoding according to any of its variants. According to another aspect, the apparatus for video decoding comprises means for implementing the method for video decoding according to any of its variants.

According to another general aspect of at least one embodiment, a 2D interpolation filter per channel of the tensor of input feature is applied to resize spatial dimension of the tensor.

According to another general aspect of at least one embodiment, at least one convolutional filter is applied to the tensor of input feature to scale the number of channels of the tensor.

According to another general aspect of at least one embodiment, information (filter type, filter coefficients, index of a filter in a pre-determined set of filters) representative of a filter to use in feature tensor resizing is parsed from metadata of the bitstream

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described decoding embodiments or variants.

According to another general aspect of at least one embodiment, there is provided a signal comprising video data generated according to any of the described decoding embodiments or variants.

According to another general aspect of at least one embodiment, a bitstream is formatted to include data content generated according to any of the described decoding embodiments or variants.

According to another general aspect of at least one embodiment, there is provided a computer program product comprising instructions which, when the program is executed by a computer, cause the computer to carry out any of the described decoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates a block diagram of an example apparatus in which various aspects of the embodiments may be implemented.

FIG. 2 illustrates a block diagram of an embodiment of traditional video encoder.

FIG. 3 illustrates a block diagram of an embodiment of traditional video decoder.

FIG. 4 illustrates a block diagram of an embodiment of an end-to-end neural-network-based video compression scheme.

FIG. 5 illustrates a block diagram of an embodiment of a basic pipeline of an NN-based machine vision processing.

FIG. 6 illustrates a block diagram of an embodiment of a basic pipeline of an NN-based video compression and machine vision processing.

FIG. 7 illustrates a block diagram of a variant embodiment of a basic pipeline of an NN-based video compression and machine vision processing in which various aspects of the embodiments may be implemented.

FIG. 8 illustrates a block diagram of a detailed embodiment of a basic pipeline an NN-based vision processing.

FIGS. 9 and 10 illustrate a generic tensor scaling method according to a general aspect of at least one embodiment.

FIG. 11 illustrates a generic decoding method implementing tensor scaling according to a general aspect of at least one embodiment.

FIGS. 12, 13, 14, 15 illustrate variant embodiments of the generic tensor scaling method.

FIG. 16 illustrates a generic method implementing parsing of information related to tensor scaling filtering according to a general aspect of at least one embodiment.

FIG. 17 shows two remote devices communicating over a communication network in accordance with an example of present principles in which various aspects of the embodiments may be implemented.

FIG. 18 shows the syntax of a signal in accordance with an example of present principles.

### DETAILED DESCRIPTION

Various embodiments relate to a video coding system in which, in at least one embodiment, it is proposed to adapt video decoding tools to hybrid machine/human vision applications. Different embodiments are proposed hereafter, introducing some tools modifications to increase coding efficiency and improve the codec consistency when both applications are targeted. Amongst others, a decoding method, and a decoding apparatus implementing a tensor resizing module based on this principle are proposed.

The present aspects are described in the context of ISO/MPEG Working Group 2, called Video Coding for Machine (VCM) and of JPEG-AI. The Video Coding for Machines (VCM) is an MPEG activity aiming to standardize a bitstream format generated by compressing either a video stream or previously extracted features. The bitstream should enable multiple machine vision tasks by embedding the necessary information for performing multiple tasks at the receiver, such as segmentation, object tracking, as well as reconstruction of the video contents for human consumption. In parallel, JPEG is standardizing JPEG-AI which is projected to involve end-to-end NN-based image compression method that is also capable to be optimized for some machine analytics tasks. One can easily envision other similar flavor of standards and forthcoming systems in the near future for VCM paradigm as use cases are already ubiquitous such as video surveillance, autonomous vehicles, smart cities etc.

The present aspects are not limited to those standardization works and can be applied, for example, to other standards and recommendations, whether pre-existing or future-developed, and extensions of any such standards and recommendations. Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

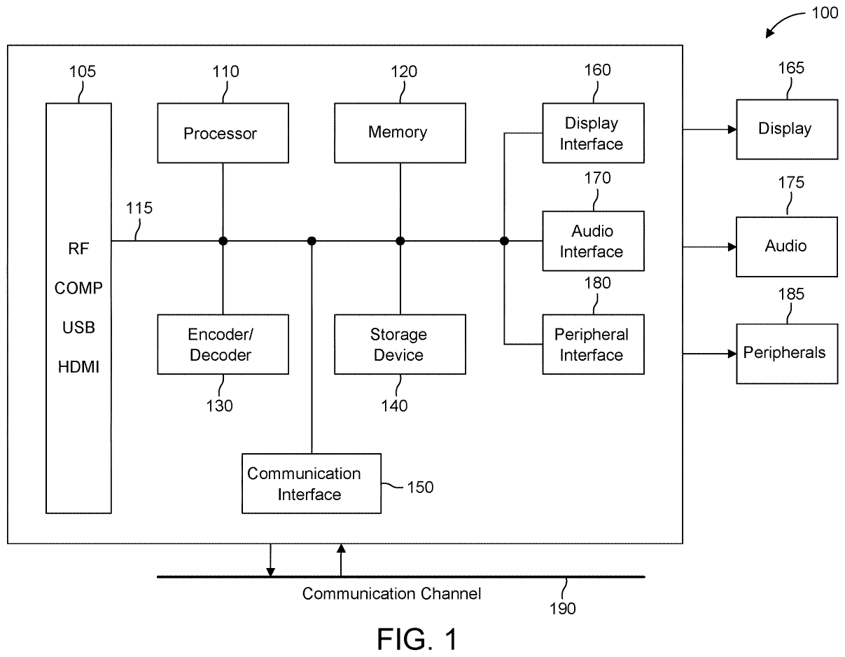

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g. a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions.

As is known, a device may include one or both of the encoding and decoding modules. Additionally, the encoder/decoder 130 module represents module(s) that may be included in a device to perform the machine vision processing (or network) on the decoded data to accomplish an inference output, thus implementing decoding tools to hybrid machine/human vision applications with NN-based tools. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic, tensor, network or filter weights.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for HEVC, or WVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

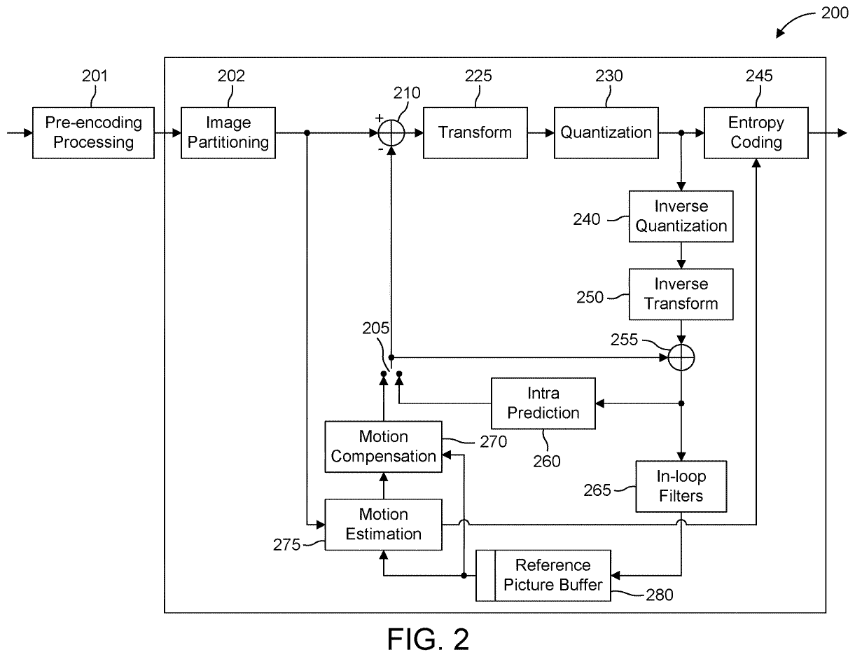

FIG. 2 illustrates an example video encoder 200, such as VVC (Versatile Video Coding) encoder. FIG. 2 may also illustrate an encoder in which improvements are made to the WVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side. Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

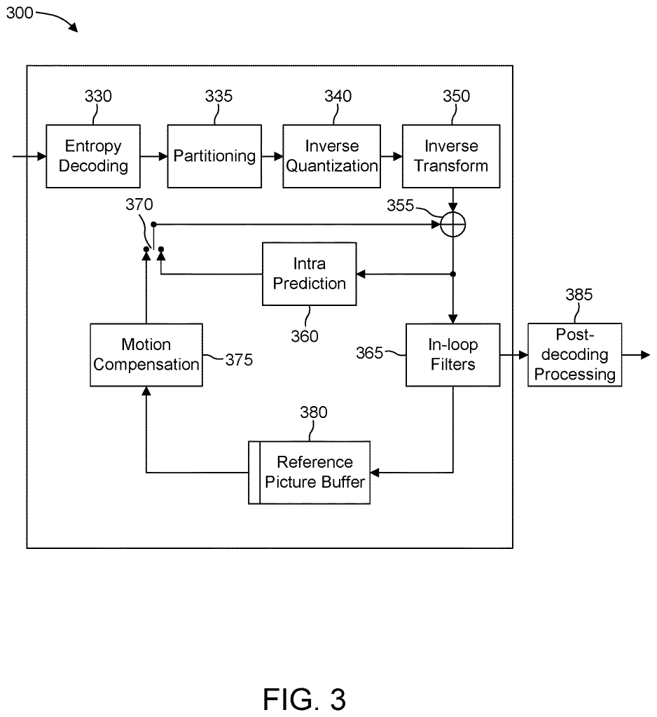

FIG. 3 illustrates a block diagram of an example video decoder 300, such as VVC decoder. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

At least some embodiments relate to a method for decoding a video using scalable NN-based transforms, the decoding further comprising rescaling/resizing a tensor of feature data intended to be fed to a NN-based vision inference task. By enabling the resizing of an estimated deep feature tensor to another tensor with a different size, the specific input size constraint imposed by the vision network can be achieved.

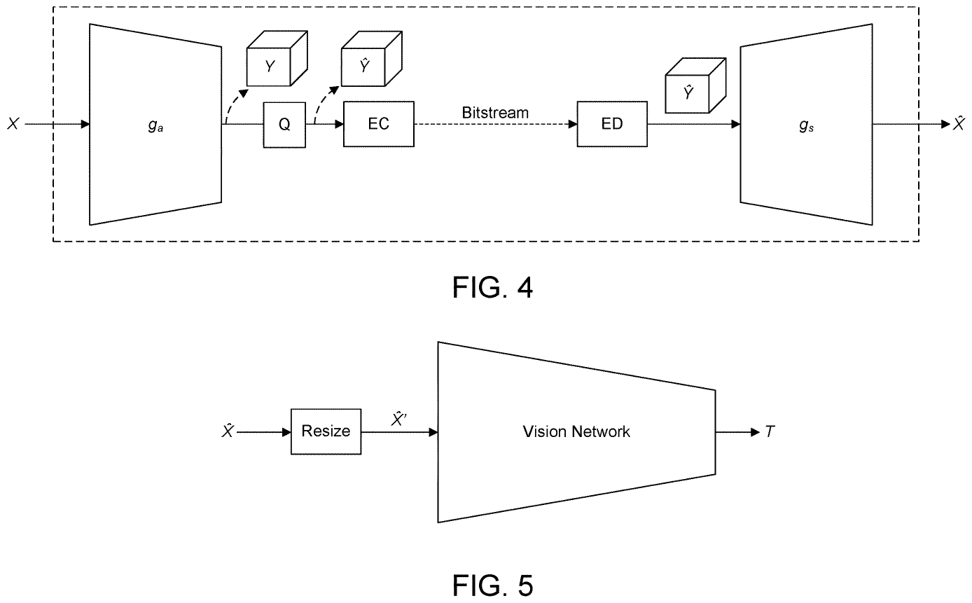

FIG. 4 illustrates a block diagram of an embodiment of an end-to-end neural-network-based video compression scheme. The encoder gₐ (also known as analysis transform) transforms the input image X is into latent space: Y=gₐ(X). In most neural network-based compression frameworks, the latent representation Y is formed in 3-dimensional tensor (referred to as a latent tensor). Then, Y is quantized (Q) and entropy coded (EC) as a binary stream (bitstream) for storage or transmission. At the decoder, the bitstream is entropy decoded (ED) to obtain Ŷ, the quantized version of Y. The decoder network gₛ (also known as synthesis transform) generates reconstructed input: \hat{X}=gₛ(Z), an approximation of the original X from the quantized latent representation Ŷ. For the sake of completeness, the skilled in the art will appreciate that, in this diagram, other modules, such as hyper-prior and context prediction used to further improve the rate-distortion performance, are omitted to keep the processing pipeline simple in the provided figure. The same style of omission for clarity will apply to the rest of the figures provided in this document.

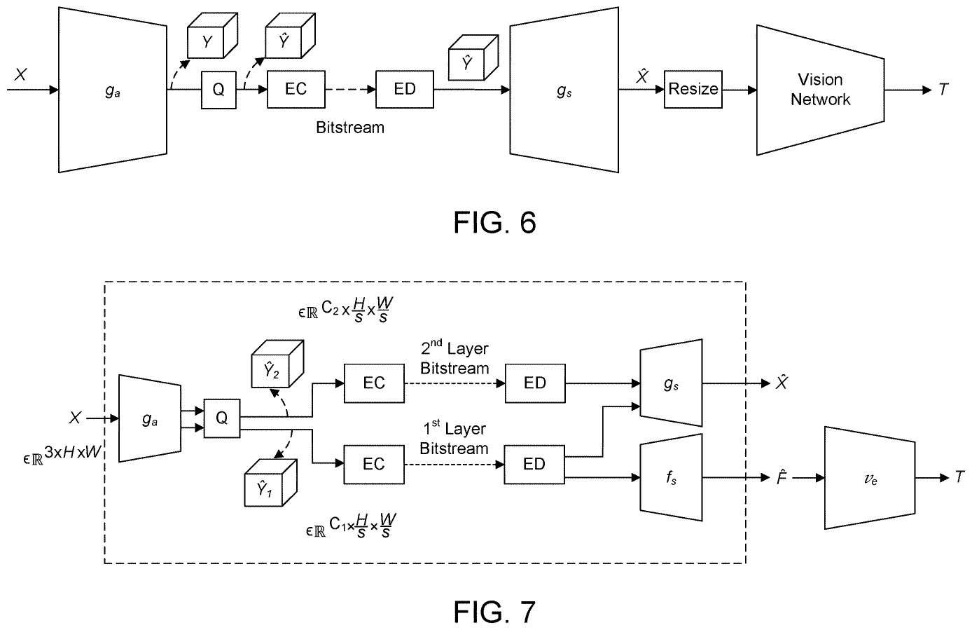

FIG. 5 illustrates a block diagram of an embodiment of a basic pipeline of a neural-network-based machine vision processing. The NN-based vision inference task (Vision Network) takes an image such as a reconstructed image \hat{X} as input. Most object detection and segmentation networks require the input to be resized to a specific resolution or to meet the constraint before conducting the inference in order to maximize the task accuracy. This is because these networks either require to be run on images of a pre-defined size or are trained on images that make it easier for the algorithm to output bounding boxes associated with object categories onto identified objects. As such, \hat{X} is first resized to \hat{X}′ and consequently, fed into the vision network to output a collection of inference results T.

Further optimizing the already existent video encoders directly for machine consumption, such as computer vision network, is not a trivial task because of the handcrafted coding tools of the compression scheme illustrated on FIGS. 2 and 3 or on FIG. 4 are optimized for rate-distortion (RD) cost only in the standard codecs. The performance of NN-based computer vision algorithms may be deteriorated by the artifacts, such as ringing, blocking artifacts and the loss of high spatial frequencies, produced by the classical standard codecs targeting human consumption.

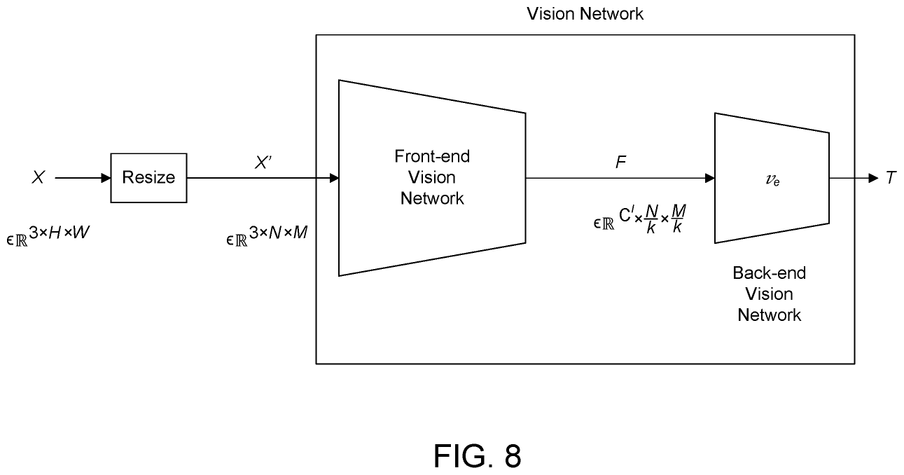

FIG. 6 illustrates a block diagram of an embodiment of a basic pipeline of an NN-based video compression and machine vision processing. According to an embodiment for the Video Coding for Machine (VCM), the scheme of FIGS. 4 and 5 are concatenated wherein the compressed input X is reconstructed and used as input to the vision network for inference in a sequential, ‘chain-like’ fashion. In this pipeline, the end-to-end compression network, including the encoder gₐ and the decoder gₛ and possibly, the vision network, can be jointly optimized for the two tasks under consideration, that are machine inference and input reconstruction, by maximizing the task accuracy altogether.

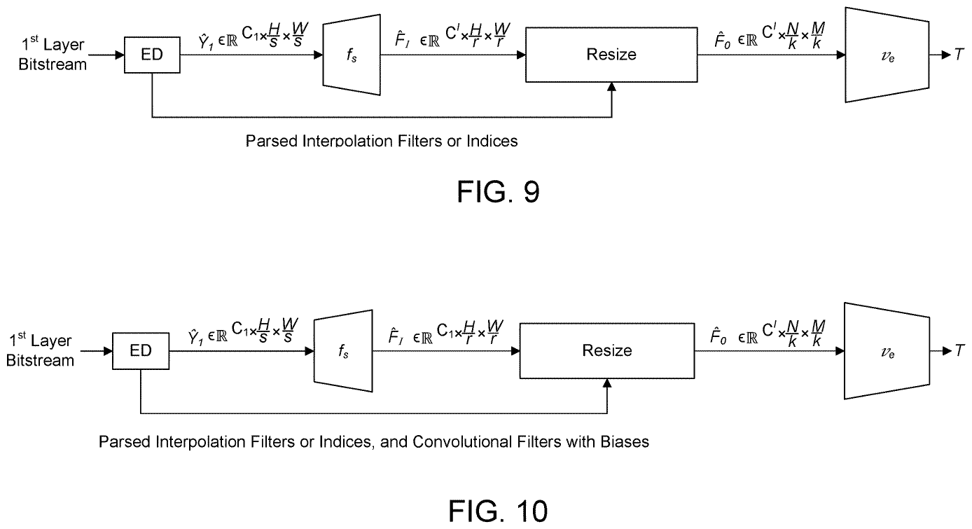

FIG. 7 illustrates a block diagram of a variant embodiment of a basic pipeline of an NN-based video compression and machine vision processing. More recently, H. Choi and I. V. Bajic in “Scalable Image Coding for Humans and Machines,” (in IEEE Transactions on Image Processing, vol. 31, pp. 2739-2754, 2022) introduced a scalable architecture of NN-based compression for VCM which is illustrated in FIG. 7. Unlike in FIG. 6, the analysis transform gₐ produces two latent tensors, which are then quantized to obtain

$${\hat{Y}}_{1} ∈ {ℝ}^{{C}_{1} \times \frac{H}{s} \times \frac{W}{s}} and$$

$${\hat{Y}}_{2} ∈ {ℝ}^{{C}_{2} \times \frac{H}{s} \times \frac{W}{s}} ,$$

where C₁ and C₂ denote the number of channels for the first (base) and the second (enhanced) latent representation, respectively. s is a scale factor between the spatial resolution of the latent tensors and the input images. This scale factor is typically determined by gₐ that generally consists of several convolutional layers with a stride of 2. Consecutively, the independently encoded latent tensors, i.e., the first and the second bitstreams, are used as input to gₐ and fₛ at the decoder side. Advantageously, this architecture is designed to support functional scalability from some simpler task (e.g., object detection) to more complicated ones (e.g., input reconstruction). For example, reconstructing every pixel with signal fidelity is desired for input reconstruction, but it is unnecessary for object detection. Therefore, the first bitstream carries information with the latent representation Ŷ₁ for object detection and the second bitstream delivers remaining latent representation Ŷ₂ containing enhancement information to be used together with Ŷ₁ for the input reconstruction. As Choi describes both two and three tasks supporting VCM architectures, the VCM framework proposed in FIG. 7 is not limited to the two tasks variant, and the skilled in the art will easily adapt the described framework to more than two tasks. For the base task (e.g., object detection), the feature synthesis module fₛ (also referred to as “latent space transform” in Choi) solely takes Ŷ₁ as input to estimate the deep feature tensor \hat{F}. This feature tensor is then input in vₑ, which corresponds to a part of the vision network starting from the l-th layer to the last layer. The vision network outputs a collection of T. In Choi, the decoder advantageously requires less computation to carry out the inference task since the front part of the vision network, from the input layer to the l−1 th layer, is already omitted by the proposed architecture. To reconstruct x, it is necessary gₛ to take the both Ŷ={Ŷ₁, Ŷ₂} as input.

However, the VCM architecture of Choi raises the issue of incompatible spatial resolution between the estimated feature tensor \hat{F} generated when compressing the input X at the original scale as shown in FIG. 7 and the expected feature tensor resolution of F, which is computed by inputting X′ the resized input into the front-end vision network as implemented in the sequential scheme of FIG. 6. Due to the inconsistent dimension between \hat{F} and F, it is highly unlikely that the compression and vision task pipeline attains optimal performance for all tasks simultaneously.

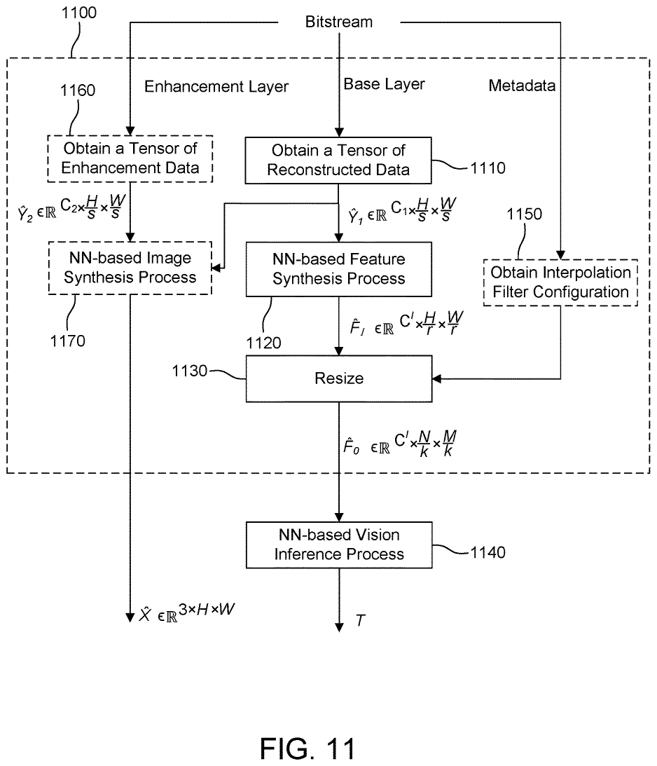

FIG. 8 illustrates a block diagram of a detailed embodiment of a basic pipeline an NN-based machine vision processing. FIG. 8 presents the detailed exemplary dimensions of the associated intermediate tensors. The input X∈ [symbol] ^{3×H×W} is resized to X′∈ [symbol] ^{3×N×M} to comply with the constraint of input resolution N×M imposed by the pretrained vision network. Then, at the intermediate layer l of the vision network, the feature tensor F turns out to have a dimension of

$${C}^{l} \times \frac{N}{k} \times \frac{M}{k} ,$$

where C^{l} denotes the number of channels at the l-th layer, and k corresponds to the scale factor between the spatial resolution of the tensor and the input image, which is typically determined by the front-end vision network that involves several convolutional layers with a stride of 2 as well as some pooling operations. Therefore, when the compression framework shown in FIG. 7 takes the resized X′ as input, instead of X, the optimal performance for the vision task is expected to be achieved as fₛ generates \hat{F} with

$${C}^{l} \times \frac{N}{k} \times \frac{M}{k}$$

since that feature tensor size meets the dimension that vₑ expects as input at the l-th layer when X′ is used as input to the front-end vision network shown in FIG. 8. In this scenario, however, gₛ would produce the reconstructed input \hat{X}′ with the resolution 3×N×M. Unless some auxiliary post processing module is incorporated to resize \hat{X}′ to the original resolution of 3×H×W, the coded bitstreams can only reconstruct the input with the resized resolution 3×N×M.

A similar issue of inconsistent resolution happens when coding X instead of X′. In that case, the reconstructed \hat{F} needs to be resized.

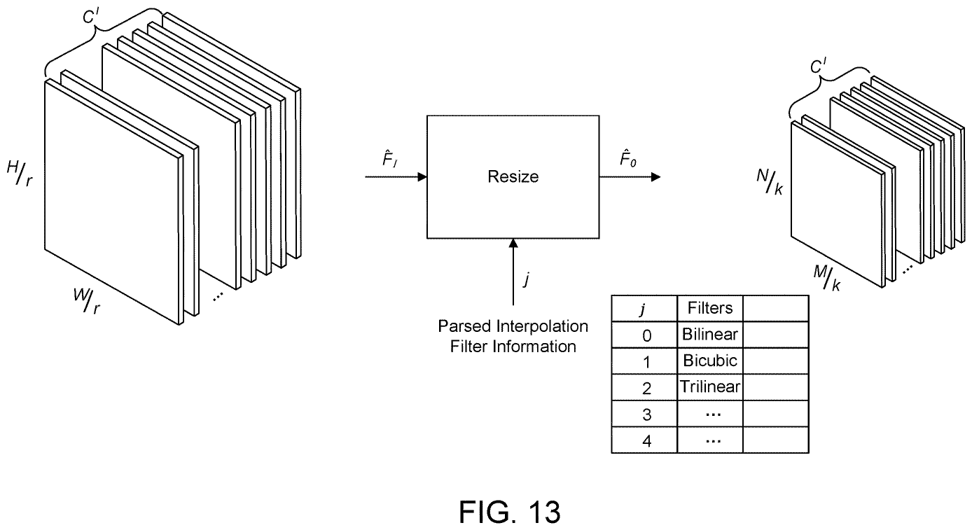

This is solved and addressed by the general aspects described herein, which are directed to a method for resizing a tensor of input feature (\hat{F}ₗ) to generate a tensor of output feature (\hat{F}_{O}), the tensor of output feature being adapted to a dimension of a neural network-based vision inference processing (vₑ). Advantageously, the resizing module is implemented at the decoder side for the case(s) producing deep feature tensor(s) for various vision task algorithms as shown on FIG. 11.

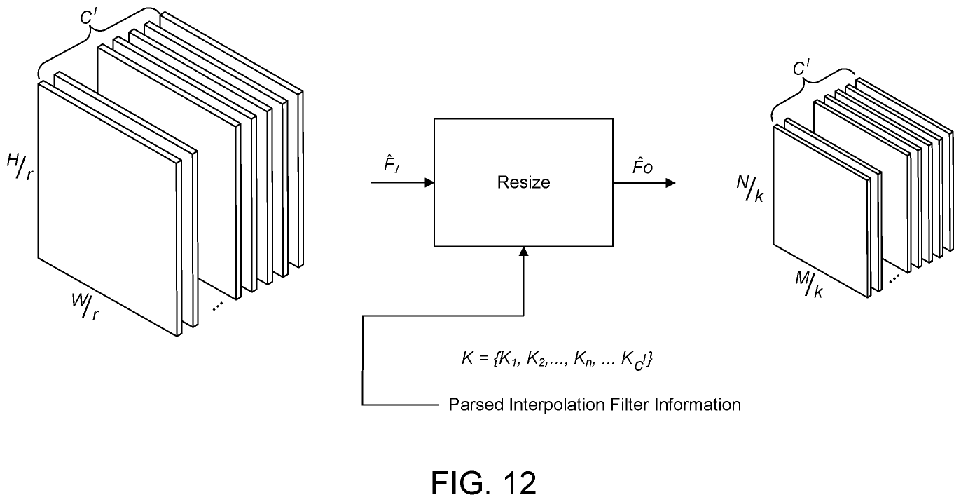

FIG. 9 illustrates a generic tensor scaling method according to a general aspect of at least one embodiment. The block diagram of FIG. 9 partially represents modules of a decoder method, for instance implemented in the exemplary decoder of FIG. 11.

A feature tensor is obtained from the decoding ED and the neural network-based feature synthesis processing fₛ of the first (base) layer bitstream at the decoder. The feature tensor is intended to be fed to the neural network-based vision inference processing vₑ to produce a result T such as segmentation, object detection, object tracking . . . . Advantageously, the decoder further includes the proposed resize operation so that the size of the feature tensor is adapted to the expected size of the tensor at the input of the NN-based vision inference processing. Therefore, the proposed resizing operation is applied to any task pipelines when supporting more than two tasks (meaning that the decoder may support more than one vision task and input reconstruction task) so that the size of the tensor of a given task pipeline (one vision task) is independent from the size of the tensor of another given task pipeline (input reconstruction task). As shown on FIG. 9, the ED firstly reconstructs a tensor of reconstructed data

$${\hat{Y}}_{1} ∈ {ℝ}^{{C}_{1} \times \frac{H}{s} \times \frac{W}{s}}$$

from the 1^{st} layer bitstream where the tensor of reconstructed data Ŷ₁ is partially representative of image data samples to reconstruct. Subsequently, Ŷ₁ is fed into the feature synthesis module fₛ to generate the feature tensor \hat{F}ₗ. The generated tensor \hat{F}ₗ can be a tensor with the rescaled spatial resolution

$$\frac{H}{r} \times \frac{W}{r} ,$$

where r is a scale determined by the architecture fₛ and the number of channels C^{l} with respect to the input channel of vₑ. Then, the resize module resizes

$${\hat{F}}_{I} ∈ {ℝ}^{{C}^{l} \times \frac{H}{r} \times \frac{W}{r}}$$

to obtain

$${\hat{F}}_{O} ∈ {ℝ}^{{C}^{l} \times \frac{H}{k} \times \frac{W}{k}}$$

using interpolation filters. These filters' information can be conveyed either by signaling an index associated with standard filters shared in the decoder or by encoding the filter coefficients in the form of some bitstream. Finally, the resized \hat{F}_{O} is used as input to vₑ to accomplish the inference task and ultimately, the output T is obtained.

FIG. 10 illustrates another generic tensor scaling method according to a general aspect of at least one embodiment. The block diagram of FIG. 10 partially represents modules of a decoder method, for instance implemented in the exemplary decoder of FIG. 11. In this variant embodiment, fₛ produces \hat{F}ₗ with the number of channels equal to C₁, instead of the expected number of channels to be C^{l} as shown in FIG. 10. In this variant, further information about a set of convolutional filters with or without bias parameters is signaled in the bitstream so that the resize module conducts not only the spatial resolution resize but also the convolutional operation to generate a tensor with resolution

$${C}^{l} \times \frac{N}{k} \times \frac{M}{k} .$$

According to yet another variant, depending on the vision task to support at each task layer, there may be different constraints on the input size and the number of input channels of vₑ.

Therefore, the proper information about interpolation filters and/or convolutional filters can be carried in each bitstream for different task layers and be applied to the feature tensors.

FIG. 11 illustrates a generic decoding method (1100) implementing tensor scaling according to a general aspect of at least one embodiment. In a preliminary step not shown on FIG. 11, a bitstream is received. As explained with in the scheme of Choi, the bitstream may comprise scalable data representative of video images including a base layer for image data intended to a computer vision task, an enhancement layer representative of additional image data intended to human vision. The bitstream may further comprises additional metadata used for processing the received bitstream. In a first step 1110, a tensor of reconstructed data Ŷₗ is obtained, the tensor of reconstructed data being partially representative of image data samples to reconstruct, the tensor of reconstructed data comprises a C¹ number of channels of two-dimensional data of size

$$\frac{H}{s} \times \frac{W}{s}$$

(with same notation as above). In a second step 1120, a NN-based feature synthesis processing is applied to tensor of reconstructed data to generate a tensor of input feature

$${\hat{F}}_{I} ∈ {ℝ}^{{C}^{l} \times \frac{H}{r} \times \frac{W}{r}}$$

representative of a feature of the image data samples, the tensor of input feature comprises a C^{l} number of channels of two-dimensional data of size

$$\frac{H}{r} \times \frac{W}{r}$$

where r is a rescaling ratio. In a step 1130, the tensor of input feature \hat{F}ₗ is resized/rescaled to generate a tensor of output feature \hat{F}_{O}. Advantageously, the resizing allows to generate a tensor of output feature \hat{F}_{O} comprising a C^{l} number of channels of two-dimensional data of size

$$\frac{N}{k} \times \frac{M}{k}$$

matching the size of the tensor expected at the neural network-based vision inference processing 1140 (indeed at a defined layer to generate a collection of inference results T.

According to another embodiment, the decoding method further comprises obtaining 1150 information on the interpolation filter to apply for the resizing according to any of the signaling variants described here after.

According to another embodiment, the decoding method further comprises, in a step 1160, obtaining a tensor of enhancement data Ŷ₂, the tensor of enhancement data being complementary representative of image data samples to reconstruct with regards to the tensor of reconstructed data Ŷ₁, the tensor of reconstructed data comprises a C² number of channels of two-dimensional data of size

$$\frac{H}{s} \times \frac{W}{s}$$

(with same notation as above). From a NN-based image synthesis processing 1170, the decoding method generates a reconstructed image of size H×W for instance to be reproduced on a display for human vision.

According to yet another embodiment, the decoding may further output additional tensor

$${\hat{F}}_{n} ∈ {ℝ}^{{C}^{p} \times \frac{N}{j} \times \frac{M}{j}}$$

intended for a different vision inference task, the NN-based feature synthesis process 1120 and the resize process 1130 are thus instantiated an additional time (in parallel steps) to output the additional tensor

$${\hat{F}}_{n} ∈ {ℝ}^{{C}^{p} \times \frac{N}{j} \times \frac{M}{j}}$$

intended to a different vision inference task having its on tensor size requirements where j is here a scale factor between the spatial resolution of the tensor and the input image for the related vision inference task.

### Various Embodiments of the Generic Decoding Method are Described in the Following

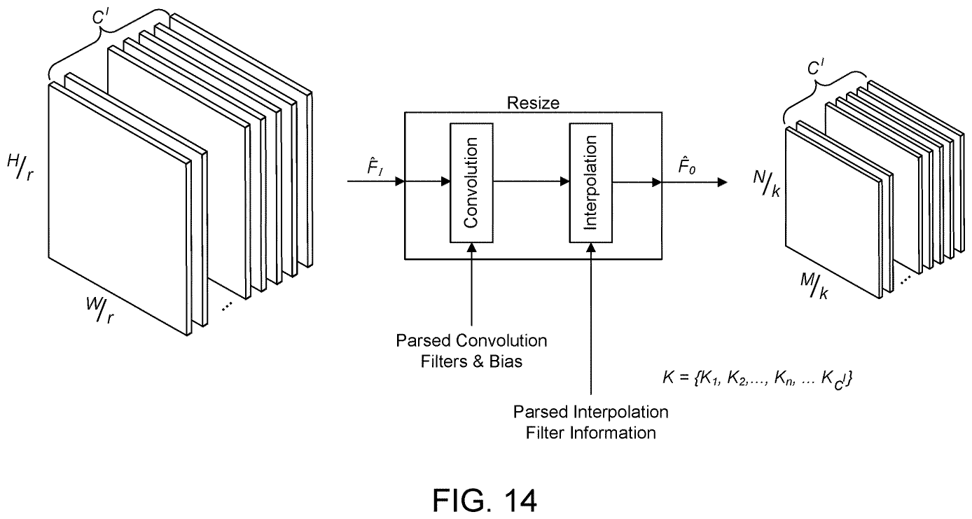

FIG. 12 illustrates a generic tensor rescaling method (1130) according to a general aspect of at least one embodiment.

According to a first variant the number (C^{l}) of channels of the tensor of input feature and the number (C^{l}) of channels of the tensor of output feature are equal. In a variant, for each channel, the 2D data of size

$$\frac{H}{r} \times \frac{W}{r}$$

of the input tensor is rescaled to 2D data of size

$$\frac{N}{k} \times \frac{M}{k}$$

by applying one 2D interpolation filter. Alternatively, for each channel, 1D-separable filters are applied to both dimension of the 2D data of size

$$\frac{H}{r} \times \frac{W}{r}$$

to generate 2D data of size

$$\frac{N}{k} \times \frac{M}{k}$$

in any order. In another variant, parameters, such as the coefficients of the interpolation filters, representative of a 2D interpolation filtering are parsed from metadata embedded the bitstream. FIG. 12 shows an example of resizing the input feature tensor

$${\hat{F}}_{I} ∈ {ℝ}^{{C}^{l} \times \frac{H}{r} \times \frac{W}{r}}$$

to obtain an output feature tensor

$${\hat{F}}_{O} ∈ {ℝ}^{{C}^{l} \times \frac{N}{k} \times \frac{M}{k}}$$

using a sequence of 2-D interpolation kernels K={K₁, K₂, . . . , Kₙ, . . . , K_{C}_{ₗ}} parsed from corresponding bitstream, where Kᵢ is used to resize i-th channel in the tensor \hat{F}ₗ. It is also possible to use separable filters for each channel instead of 2-D kernels, and this can be indicated in the bitstream.

FIG. 13 illustrates another generic tensor rescaling method (1130) according to a general aspect of at least one embodiment.

In yet another variant, a set of 2D interpolation filters are predefined in the decoder, such as a bilinear filter, a bi-cubic filter, a trilinear filter. An index indicating a 2D interpolation filter among a set of interpolation filters may be parsed from metadata embedded the bitstream.

As shown on FIG. 13, the input feature tensor

$${\hat{F}}_{I} ∈ {ℝ}^{{C}^{l} \times \frac{H}{r} \times \frac{W}{r}}$$

is resized to obtain the output feature tensor

$${\hat{F}}_{O} ∈ {ℝ}^{{C}^{l} \times \frac{N}{k} \times \frac{M}{k}}$$

using a filter pre-existing in the decoder. In this variant, only the index j is parsed from the bitstream, and then the corresponding interpolation filter with j is applied to all channels in \hat{F}ₗ to output

$${\hat{F}}_{O} ∈ {ℝ}^{{C}^{l} \times \frac{N}{k} \times \frac{M}{k}} .$$

According to yet another variant, it is possible to choose different interpolation filters for different channels by parsing multiple filter indices from the bitstream.

In a variant combining embodiments of FIG. 12 and FIG. 13, each channel can have different filter type among pre-defined filter (bilinear, bicubic, etc.) and a customized adaptive filter with coefficients. In this case, an individual filter index associated with each channel is signaled which covers any of the filter embodiments. For the case where the filter index presents the use of adaptive filter, subsequently transferred filter coefficients should be properly parsed to be used for that channel.

FIG. 14 illustrates another generic tensor rescaling method (1130) according to a general aspect of at least one embodiment.

According to a second variant, the number of channels C₁ of the tensor of input feature and the number of channels C^{l} of the tensor of output feature are different. Accordingly resizing the tensor of input feature further comprises applying at least one convolutional filter to the tensor of input feature to scale the number of channels. Indeed, For use cases where \hat{F}_{I} has a different number of channels than \hat{F}_{O} (i.e., C₁ rather than C^{l}), one must also resize the tensor along the channel axis, in addition to the spatial axes. One way to resize the number of channels is to conduct a convolutional operation with relevant filter information that should be transmitted in the bitstream. FIG. 14 shows the method for resizing the input feature tensor

$${\hat{F}}_{I} ∈ {ℝ}^{{C}_{1} \times \frac{H}{r} \times \frac{W}{r}} to {\hat{F}}_{O} ∈ {ℝ}^{{C}^{l} \times \frac{N}{k} \times \frac{M}{k}}$$

using parsed filter information obtained from the bitstream. A convolutional operation is shown that precedes the spatial interpolation operation. However, it is also possible to swap the order of these operations. The parsed convolutional filters can include a set of filters with a kernel size and bias terms if needed. Then, the output of the convolution block generates an intermediate tensor with the channels C^{l}. Subsequently, the intermediate tensor will be spatially resized by the parsed interpolation filters obtained from the bitstream to produce

$${\hat{F}}_{O} ∈ {ℝ}^{{C}^{l} \times \frac{N}{k} \times \frac{M}{k}} .$$

According to yet another variant, the resize network may be more complex than presented in FIGS. 12-14. The resize network may include, but not limited to, more than one convolution layer or any type of trainable layers and activation layers before the interpolation or even after the interpolation filter. In this case, not only the filter coefficient, but also all the corresponding weights for the layers constructing the resize network should be signaled to decoder. According to non-limiting examples, the layers of the resize network may include, fully connected layer, convolutional layer, deconvolutional layer, pooling layer such as max pooling, average pooling, activation layer.

FIG. 15 illustrates another generic tensor rescaling method (1130) according to a general aspect of at least one embodiment. On the variant shown on FIG. 15, the input feature tensor

$${\hat{F}}_{I} ∈ {ℝ}^{{C}_{1} \times \frac{H}{r} \times \frac{W}{r}}$$

is resized to yield

$${\hat{F}}_{O} ∈ {ℝ}^{{C}^{l} \times \frac{N}{k} \times \frac{M}{k}}$$

with a filter pre-existing in the decoder for this spatial interpolation operation. For the convolutional operation, the same process described above for FIG. 14 is applied to generate the intermediate tensor with number the channels equal to C^{l}. Then, the intermediate tensor will be spatially resized by the interpolation filter corresponding to index j parsed from the bitstream to generate

$${\hat{F}}_{O} ∈ {ℝ}^{{C}^{l} \times \frac{N}{k} \times \frac{M}{k}}$$

as described with FIG. 13.

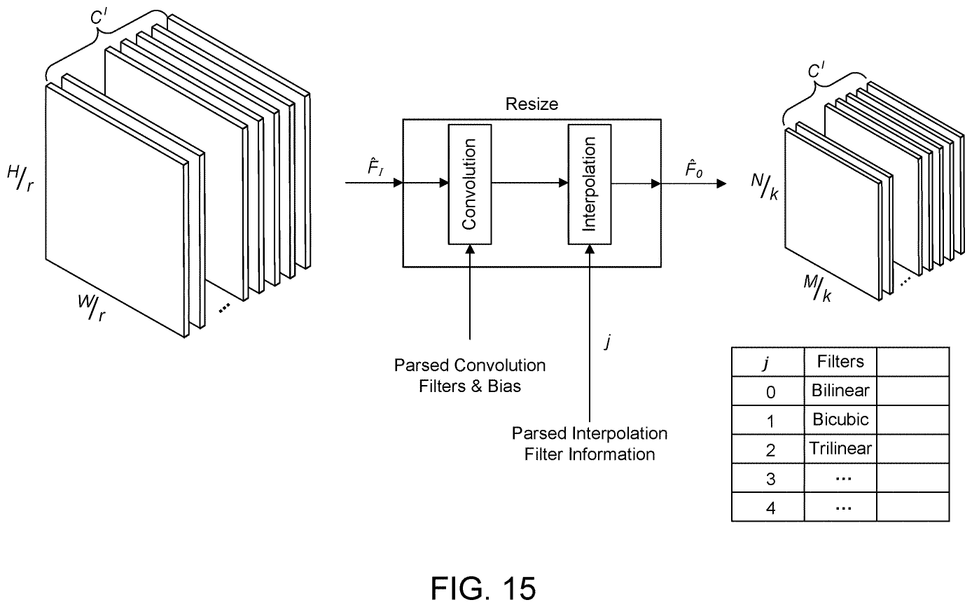

FIG. 16 illustrates a generic method implementing parsing of information related to tensor scaling filtering according to a general aspect of at least one embodiment.

According to a variant embodiment, a process of parsing filter information from the bitstream to resize the relevant tensors is described. This process can be carried at the parsing of an individual bitstream associated with each task pipeline. In a first step 1610, a flag indicating the need for resizing the input tensor for the vision inference task is received and parsed. Responsive to the need for resizing the input tensor being true (flag being equal 1), further information about the resizing filters is parsed in 1620. Responsive to no need to resize the input tensor at the output of the synthesis module (flag being inferred to 0), the method ends. When the flag is equal to 1, it may need to parse the target size or resolution to be generated by the resizing module to comply with the associated vision task network. Furthermore, there is a flag indicating if parsing the target size is needed. If the flag is equal to 0, relevant information can be inferred 1630 by referencing a configuration associated with the vision network. If the flag is equal to 1, the target dimension to be achieved by the resize module can be parsed 1640. For example, the process parses 1640 the number of channels, width, and height of the output feature tensor by the resizing module. For example, the process parses 1640 a scaling factor for each of the tensor dimension (channel, width, and height) between the input and the output channel. Subsequently, num_filter_minus_1 is parsed 1650 to specify how many filters will be applied to resize the input feature tensor. Therefore, the actual number of filters to apply corresponds to num_filter_minus_1+1. In a variant, a filter type can then be consecutively parsed 1660. To give some examples, the filter type can be convolutional filter, interpolation filter, etc. Depending on the filter type, relevant parsing process can be involved to parse filter coefficients and relevant information about the filter. After parsing the information associated with the filter, I.e., the filter type and coefficients, etc., the same parsing flow is repeated to parse the rest of filter information until 1670 the number of parsed filter sets meet the num_filter_minus_1+1. The parsed filter information is the same as the order to apply the filter to the input tensor in the resize module.

Normative methods to describe, compress and transmit neural network parameters have already been standardized. For instance, the so-called MPEG Neural Network Representations standard (NNR) provides tools and syntax to compress and transmit neural networks. It can be envisioned to use NNR as means to transmit the parameters of the proposed filters as they are generally composed of convolutional operations that are supported by NNR. If no compression is needed, for instance in the case of the size of the kernel parameters being negligible, exchange formats such as ONNX or NNEF can also be used as a syntax to specify the filter structure and its parameter values.

Such described syntax for machine vision processing may include additional information for instance related to the image, a part of the image or the bitstream itself that may be shared by both human and machine vision tasks. For instance, the additional information may include, but are not limited to, padding size for input image, input image resolution. These information typically exist in the bitstream for input reconstruction (traditional image/video codec), and the skilled in the art appreciate that such information are also needed for the vision task bitstream and should therefore be available for the vision task bitstream in particular since present principles are adapted to scalable bitstream. According to another variant, in case that the encoder codes only region of interest, it would be necessary for the decoder to know the top-left corner coordinates, width and height of the coded area. For instance, the additional information may include, but are not limited to, top-left corner coordinates of a coded area, width and height of the coded area. According to yet other variant, details of vision network configuration and network architecture should be useful, especially the layers interfacing with encoder and decoder (resize module) and signaled as additional data.

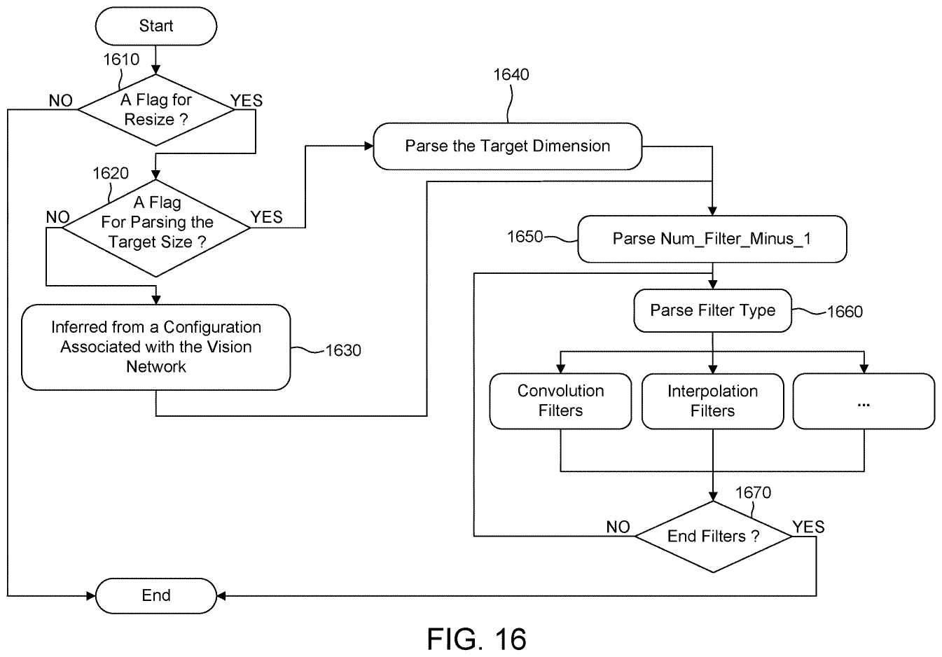

FIG. 17 shows two remote devices communicating over a communication network in accordance with an example of present principles in which various aspects of the embodiments may be implemented. According to an example of the present principles, illustrated in FIG. 17, in a transmission context between two remote devices A and B over a communication network NET, the device A comprises a processor in relation with memory RAM and ROM which are configured to implement any one of the embodiments of the method for NN scalable encoding as described in relation with the FIG. 7 and the device B comprises a processor in relation with memory RAM and ROM which are configured to implement any one of the embodiments of the method for NN scalable decoding for hybrid human/machine vision application as described in relation with FIG. 7, 9-11 or 16. In accordance with an example, the network is a broadcast network, adapted to broadcast/transmit encoded images from device A to decoding devices including the device B. A signal, intended to be transmitted by the device A, carries at least one scalable bitstream comprising coded data representative of at least one image along with metadata allowing to apply the resizing information. According to yet another embodiment, an encoding method, and an encoding apparatus embedding signaling information on a tensor resizing module implemented at the decoder and based on the present principles are proposed.

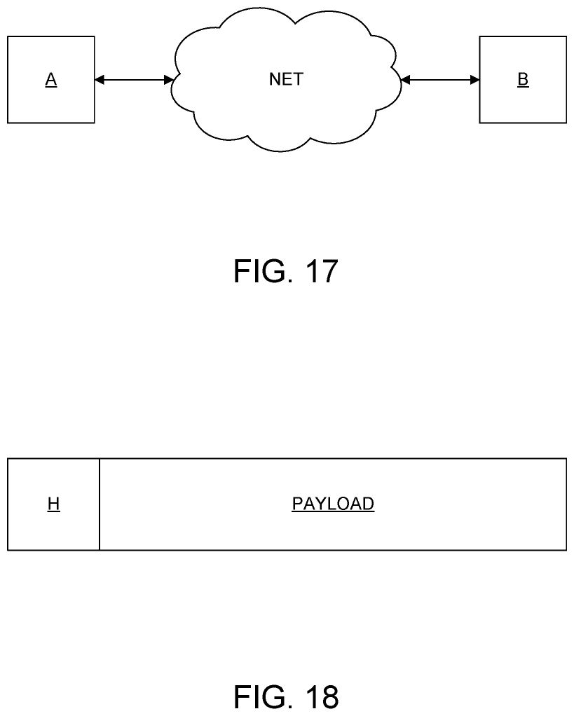

FIG. 18 shows an example of the syntax of such a signal when the at least one coded image is transmitted over a packet-based transmission protocol. Each transmitted packet P comprises a header H and a payload PAYLOAD. The payload PAYLOAD may carry the above described scalable bitstream including metadata relative to machine vision application. In a variant, the payload comprises scalable neural-network based coded data representative of image data samples for a neural network-based vision inference processing and associated metadata, wherein the associated metadata comprises at least one of an indication of a resizing of a tensor of input feature; an indication on whether the resizing is inferred from a configuration associated with an expected dimension of the neural network-based vision inference processing or the resizing is embedded from the associated metadata of the bitstream; one or more parameters representative of a resized dimension of tensor of output feature; an indication of a number of interpolation filters used in the resizing; and one or more parameters representative of an interpolation filter among a number of interpolation filters used in the resizing.

### Additional Embodiments and Information

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”. “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented as various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message.

Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation; RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Adapting the size of a feature tensor intended for machine vision task in a NN-based scalable decoder and/or encoder.
Selecting a filter to apply for resizing a feature tensor in the decoder and/or encoder.
Signaling an information relative to resizing of a feature tensor to apply in the decoder.
Deriving an information relative to a filtering process to apply for resizing a feature tensor, the deriving being applied in the decoder and/or encoder.
Inserting in the signaling syntax elements that enable the decoder to identify the filtering process to use, such as filter indices.
Selecting, based on these syntax elements, the at least one filtering process to apply at the decoder.
A bitstream or signal that includes one or more of the described syntax elements, or variations thereof.
A bitstream or signal that includes syntax conveying information generated according to any of the embodiments described.
Inserting in the signaling syntax elements that enable the decoder to apply a feature tensor resizing process in a manner corresponding to that used by an encoder.
Creating and/or transmitting and/or receiving and/or decoding a bitstream or signal that includes one or more of the described syntax elements, or variations thereof.

Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs a NN-based scalable decoding process adapted to resize a feature tensor intended for machine vision task according to any of the embodiments described.

A TV, set-top box, cell phone, tablet, or other electronic device that performs a NN-based scalable decoding process adapted to resize a feature tensor intended for machine vision task according to any of the embodiments described, and that displays (e.g. using a monitor, screen, or other type of display) an image intended for human vision.

A TV, set-top box, cell phone, tablet, or other electronic device that selects (e.g. using a tuner) a channel to receive a signal including an encoded image, and that performs a NN-based scalable decoding process adapted to resize a feature tensor intended for machine vision task according to any of the embodiments described.
A TV, set-top box, cell phone, tablet, or other electronic device that receives (e.g. using an antenna) a signal over the air that includes an encoded image, and that performs a NN-based scalable decoding process adapted to resize a feature tensor intended for machine vision task according to any of the embodiments described.

1. A method, comprising:
obtaining a tensor of reconstructed data representative of image data samples partially reconstructed from a base layer of a scalable bitstream, the tensor of reconstructed data comprises a first number of channels of two-dimensional data, reconstructed data having an input spatial resolution;
applying to the tensor of reconstructed data a neural network-based feature synthesis processing to generate a tensor of input feature representative of a feature of image data samples, the tensor of input feature comprises a second number of channels of two-dimensional data;
resizing the tensor of input feature to generate a tensor of output feature, the tensor of output feature comprises a third number of channels of two-dimensional data, wherein output feature data have an output spatial resolution that is an arbitrary ratio of the input spatial resolution; and
applying to the tensor of output feature, a neural network-based vision inference processing to generate a collection of inference results;
wherein resizing the tensor of input feature comprises applying at least one interpolation filter to the tensor of input feature to adapt at least a dimension of the tensor of input feature to the neural network-based vision inference processing.

2. An apparatus comprising a memory and one or more processors, wherein the one or more processors are configured to:
obtain a tensor of reconstructed data representative of image data samples partially reconstructed from a base layer of a scalable bitstream, the tensor of reconstructed data comprises a first number of channels of two-dimensional data, reconstructed data having an input spatial resolution;
apply to the tensor of reconstructed data a neural network-based feature synthesis processing to generate a tensor of input feature representative of a feature of image data samples, the tensor of input feature comprises a second number of channels of two-dimensional data;
resize the tensor of input feature to generate a tensor of output feature, the tensor of output feature comprises a third number of channels of two-dimensional data, wherein output feature data have an output spatial resolution that is an arbitrary ratio of the input spatial resolution; and
apply to the tensor of output feature, a neural network-based vision inference processing to generate a collection of inference results;
wherein to resize the tensor of input feature, at least one interpolation filter is applied to the tensor of input feature to adapt at least a dimension of the tensor of input feature to the neural network-based vision inference processing.

3. The method of claim 1, wherein the second number of channels of the tensor of input feature and the third number of channels of the tensor of output feature are equal and wherein resizing the tensor of input feature further comprises applying one 2D interpolation filter per channel of the tensor of input feature.

4. The method of claim 1, wherein the second number of channels of the tensor of input feature and the third number of channels of the tensor of output feature are equal and wherein resizing the tensor of input feature further comprises applying a same 2D interpolation filter for each channel of the tensor of input feature.

5. The method of claim 3, further comprising obtaining parameters representative of a 2D interpolation filter from metadata of the scalable bitstream.

6. The method of claim 4, further comprising obtaining an index from metadata of the scalable bitstream, the index indicating an interpolation filter among a set of interpolation filters.

7. The method of claim 1, wherein the second number of channels of the tensor of input feature and the third number of channels of the tensor of output feature are different and wherein resizing the tensor of input feature further comprises applying at least one convolutional filter to the tensor of input feature to scale the second number of channels.

8. The method of claim 7, further comprising obtaining parameters representative of at least one convolutional filter from metadata of the scalable bitstream.

9. The method of claim 8, wherein obtaining parameters representative of at least one interpolation filter from metadata of the scalable bitstream further comprises:
parsing a flag indicating a resizing of the tensor of input feature,
responsive to the flag indicating a resizing of the tensor of input feature, parsing a flag indicating whether the resizing is inferred from a configuration associated with an expected dimension of the neural network-based vision inference processing or the resizing is obtained from metadata of the scalable bitstream; and
responsive to the flag indicating the resizing is obtained from metadata of the scalable bitstream, parsing parameters representative of a resized dimension of tensor of output feature, parsing an indication of a number of interpolation filters used in the resizing, parsing parameters representative of an interpolation filter among the number of interpolation filters used in the resizing.

10. The method of claim 1, further comprising
obtaining a tensor of enhancement data representative of image data samples partially reconstructed from an enhancement layer of the scalable bitstream;
applying to the tensor of reconstructed data and to a tensor of enhancement data, a neural network-based image synthesis processing to generate a reconstructed image.

11-16. (canceled)

17. A non-transitory computer readable medium storing a bitstream comprising scalable neural-network based coded data representative of image data samples for a neural network-based vision inference processing and associated metadata, wherein the associated metadata comprises at least one of:
an indication of a resizing of a tensor of input feature;
an indication on whether the resizing is inferred from a configuration associated with an expected dimension of the neural network-based vision inference processing or the resizing is embedded from the associated metadata of the bitstream;
one or more parameters representative of a resized dimension of tensor of output feature;
an indication of a number of interpolation filters used in the resizing; and
one or more parameters representative of an interpolation filter among a number of interpolation filters used in the resizing.

18. (canceled)

19. The apparatus of claim 2, wherein the second number of channels of the tensor of input feature and the third number of channels of the tensor of output feature are equal and wherein resizing the tensor of input feature further comprises applying one 2D interpolation filter per channel of the tensor of input feature.

20. The apparatus of claim 2, wherein the second number of channels of the tensor of input feature and the third number of channels of the tensor of output feature are equal, and wherein being configured to resize the tensor of input feature comprises being configured to apply a same 2D interpolation filter for each channel of the tensor of input feature.

21. The apparatus of claim 19, wherein the one or more processors are configured to obtain parameters representative of a 2D interpolation filter from metadata of the scalable bitstream.

22. The apparatus of claim 20, wherein the one or more processors are configured to obtain an index from metadata of the scalable bitstream, the index indicating an interpolation filter among a set of interpolation filters.

23. The apparatus of claim 2, wherein the second number of channels of the tensor of input feature and the third number of channels of the tensor of output feature are different, and wherein being configure to resize the tensor of input feature comprises being configured to apply at least one convolutional filter to the tensor of input feature to scale the second number of channels.

24. The apparatus of claim 23, wherein the one or more processors are configured to obtain parameters representative of at least one convolutional filter from metadata of the scalable bitstream.

25. The apparatus of claim 24, wherein being configured to obtain parameters representative of at least one interpolation filter from metadata of the scalable bitstream comprises being configured to:
parse a flag indicating a resizing of the tensor of input feature,
responsive to the flag indicating a resizing of the tensor of input feature, parse a flag indicating whether the resizing is inferred from a configuration associated with an expected dimension of the neural network-based vision inference processing or the resizing is obtained from metadata of the scalable bitstream; and
responsive to the flag indicating the resizing is obtained from metadata of the scalable bitstream, parse parameters representative of a resized dimension of tensor of output feature, parse an indication of a number of interpolation filters used in the resizing, parse parameters representative of an interpolation filter among the number of interpolation filters used in the resizing.

26. The apparatus of claim 2, wherein the one or more processors are configured to:
obtain a tensor of enhancement data representative of image data samples partially reconstructed from an enhancement layer of the scalable bitstream; and
apply to the tensor of reconstructed data and to a tensor of enhancement data, a neural network-based image synthesis processing to generate a reconstructed image.
